(19) United States
(12) Patent Application Publication
(10) Pub. No.: US 2008/0209496 A1
(43) Pub. Date: Aug. 28, 2008

(54) POWER MANAGEMENT METHOD AND SYSTEM OF SET-TOP BOX, AND POWER MANAGEABLE SET-TOP BOX

(75) Inventor: Choon-Jae JUNG, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/039,090

(22) Filed: Feb. 28, 2008

(30) Foreign Application Priority Data
Feb. 28, 2007 (KR) 2007-0020455

(51) Int. Cl. H04N 7/173

(52) U.S. Cl. 725/131

(57) ABSTRACT

A power management system of a set-top box includes a display module, connected to the set-top box via a video terminal, for transmitting video terminal information, produced by video terminal selection of a user, to the set-top box; and the set-top box, when the video terminal information is received from the display module, allowing the detected video terminal, corresponding to the video terminal information, to output video signals, and preventing other video terminals from outputting video signals. The power consumption of the set-top box can be reduced by receiving the information of a connected video terminal from a TV and controlling the other video terminals based upon the information.

### PRIORITY

This application claims priority under 35 U.S.C. §119(a) to a Korean Patent Application filed in the Korean Intellectual Property Office on Feb. 28, 2007, and there duly assigned Serial No. 2007-0020455, the contents of which are incorporated herein by reference.

### BACKGROUND OF THE INVENTION

1. Field of the Invention

The present invention relates to a power management system and method of a set-top box, and a power manageable set-top box.

2. Description of the Related Art

A digital broadcast receiver, also called a “set-top box,” is used for receiving terrestrial or satellite broadcasting. The term of set-top box is self-explanatory, meaning a “box that sits on top of a TeleVision (TV) set”. The set-top box converts satellite or cable signals to video signals for a regular TV, and/or provides various additional functions to a user, such as enabling a regular TV to be used as an interactive device. When connected to a communication line, such as a telephone line, a TV cable or an Digital Subscriber Line (DSL), the set-top box may allow the user to enjoy Internet surfing without a computer. The size of the set-top box is similar to the size of a VCR. the set-top box can support various broadcasting types, such as cable TV programs, satellite broadcasting, Internet TV programs, etc.

As shown in FIG. 1, a conventional set-top box 200 has video output terminals such as an S-Video terminal 22, a component terminal 23, a Digital Visual Interface (DVI) terminal 24 and a High Definition Multimedia Interface (HDMI) terminal 25. A controller 20 of the set-top box 200 generates video signals to all the video output terminals 22 to 25. A video display module 100, such as a TV, has one or more video input terminals 12 to 15, each of which corresponds to one of the video output terminals 22 to 25. Video signals, input through the video input terminals 12 to 15 from terminals 22 to 25, are displayed to the user controlled by a controller 10.

Since video signals are generated by respective terminals, the conventional set-top box has problems of high power consumption and generates a great amount of heat.

### SUMMARY OF THE INVENTION

The present invention has been made to solve at least the foregoing problems and/or disadvantages mentioned above and to provide at least the advantages described below. Accordingly, the present invention provides a power management system and method of a set-top box, that is, a set-top box supporting at least one video terminal, in which power consumption of the set-top box can be reduced by controlling the operation of video terminals except for a video terminal connected to a TV set. According to an aspect of the present invention, the power management system of a set-top box includes a display module connected to the set-top box via a video terminal, for transmitting video terminal information produced by video terminal selection of a user to the set-top box; and the set-top box, when the video terminal information is received from the display module, allowing the detected video terminal corresponding to the video terminal information, to output video signals and preventing other video terminals from outputting video signals.

The display module includes a digital video terminal and a display controller, which transmits the video terminal information produced by the video terminal selection of the user to the set-top box.

The set-top box includes a terminal setting unit detecting a video terminal, connected to the display module, based upon the video terminal information, which is received from the display module, and a controller allowing the detected video terminal corresponding to the video terminal information, to output video signals, and preventing other video terminals from outputting video signals. According to another aspect of the present invention, the power management method of a set-top box includes transmitting, from a display module, video terminal information produced by terminal mode selection of a user, to a set-top box via a digital video terminal; and when the video terminal information is received from the display module via the digital video terminal, allowing, from the set-top box, a video terminal corresponding to the received video terminal information, to output video signals and preventing other video terminals from outputting video signals.

According to another aspect of the present invention, the set-top box includes a power control unit, which, when video terminal information produced by terminal mode selection of a user is received from a connected display module, allows a video terminal corresponding to the video terminal information to output video signals and prevents other video terminals from outputting video signals.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the construction of a conventional system, which includes a regular TV set and a set-top box;

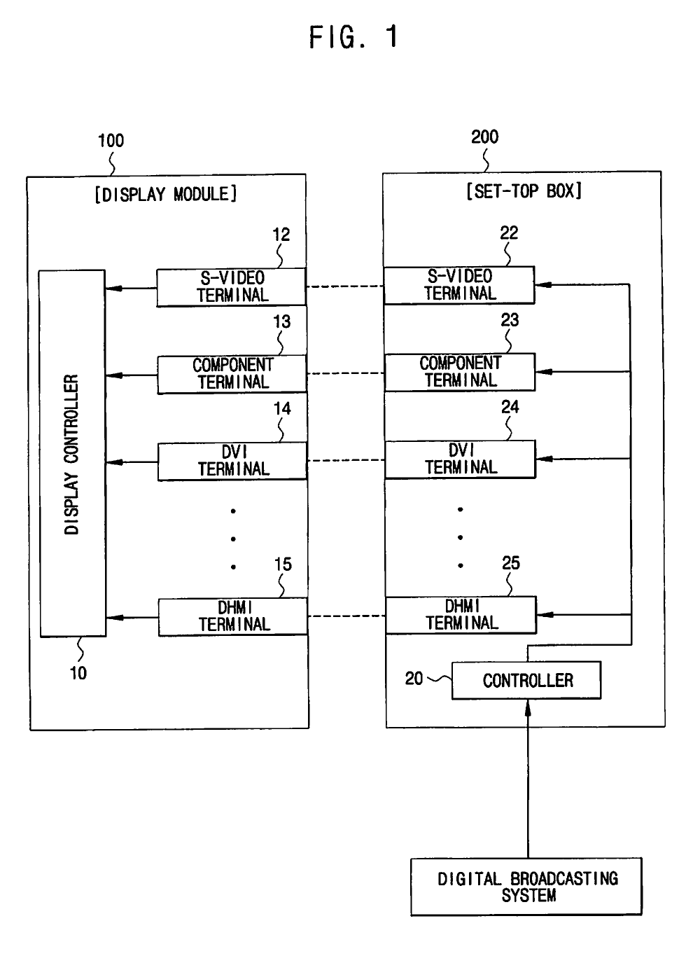

FIG. 2A is a block diagram illustrating the construction of a power management system of a set-top box according to the present invention;

FIG. 2B is a block diagram illustrating the detailed construction of the set-top box in the power management system shown in FIG. 2A;

FIG. 3 is a flowchart illustrating a power management method of a set-top box according to the present invention;

FIG. 4 is a flowchart illustrating an on/off control process of a display module in the power management method of a set-top box according to the present invention;

FIG. 5A is a block diagram illustrating the construction of a power manageable set-top box according to the present invention; and

FIG. 5B is a block diagram illustrating the detailed construction of the set-top box in the power management system shown in FIG. 5A.

### DETAILED DESCRIPTION OF THE PREFERRED EMBODIMENTS

Hereinafter, preferred embodiments of the present invention will now be described more fully hereinafter with reference to the accompanying drawings. In the drawings, the same or similar elements are demoted by the same reference numerals even though they may be depicted in different drawings. In the following description, a detailed description of known functions and configurations incorporated herein has been omitted for clarity and conciseness.

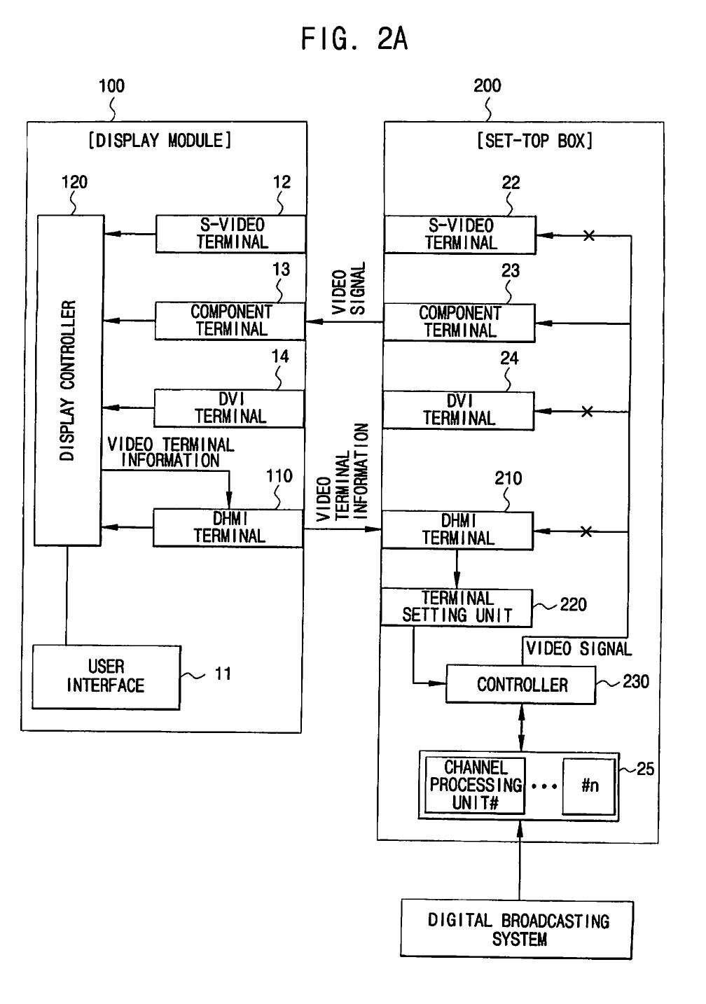

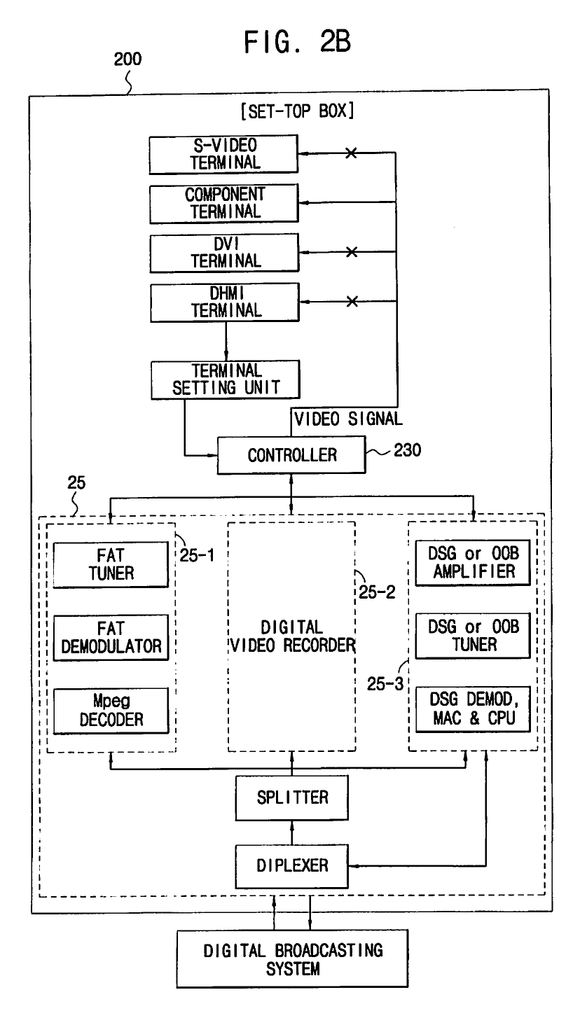

FIG. 2A is a block diagram illustrating the construction of a power management system of a set-top box according to the present invention. Referring to FIG. 2A, the power management system of a set-top box of the present invention includes a display module 100 and a set-top box 200. The display module 100 includes a user interface 11, an S-video terminal 12, a component terminal 13, a DVI terminal 14, a HDMI terminal 110 acting as a digital video terminal and a display controller 120. The set-top box 200 includes an S-video terminal 22, a component terminal 23, a DVI terminal 24, a HDMI terminal 210, a terminal setting unit 220, a controller 230 and one or more channel processing units 25. When a user selects video terminal information using the user interface 11, the display module 110 transmits the selected video terminal information via the HDMI terminal 100 to the set-top box 200. Herein, the user interface 11 indicates a remote control or input buttons of a TV set.

The HDMI terminal 110 of the display module 100 is connected to the HDMI terminal 210 of the set-top box 200, and transmits the video terminal information from the display module 100 to the set-top box 200 and when the set-top box 200 is connected to the display module 100 via the component terminals 13 and 23 for transmitting the video signal, and the display module 100 transmits the video terminal information to the set-top box 200.

When the user selects a terminal mode using the user interface 11, the display controller 120 of the display module 100 transmits corresponding video terminal information to the set-top box 200.

When the video terminal information, selected by the user, is received from the connected display module 100 via a digital video terminal such as the HDMI terminal 210, the set-top box 200 controls signal outputs of the video terminals, so that only the video terminal corresponding to the video terminal information outputs video signals, while other video terminals do not output video signals.

The HDMI terminal 210 of the set-top box 200 is connected to the HDMI terminal 110 of the display module 100, and acts as an interface that transmits/receives video signals to/from the HDMI terminal 110, and transmits the video terminal information from the display module 100 to the set-top box 200.

The terminal setting unit 220 of the set-top box 200 receives the video terminal information from the display module 100 via a digital video terminal such as the HDMI terminal 210 to detect a video terminal connected to the display module 100.

The controller 230 of the set-top box 200 controls signal outputs of the video terminals, so that only the video terminal connected to the display module 100 via the terminal setting unit 220 outputs video signals while the other video terminals do not output video signals. Since the controller 230 generates video signals for respective video terminals, the control of signal outputs is achieved by controller 230 to generate video signals of a corresponding video terminal but not to generate video signals of the other video terminals.

The controller 230 of the set-top box 200 determines on/off information of the display module based upon whether the video terminal information is received from the display module 100 in a predetermined reference time. If the display module 100 is in the off state, the controller 230 of the set-top box 200 controls the operation of the channel processing units 25 that process different types of video signals, received from a digital broadcasting system.

FIG. 2B is a block diagram illustrating the detailed construction of the set-top box in the power management system shown in FIG. 2A. Referring to FIG. 2B, the channel processing units 25 include a first, a second and a third channel processing units 25-1, 25-2 and 25-3. The first channel processing unit 25-1 includes a Forward Application Transport (FAT) tuner, a FAT demodulator, a Motion Picture Experts Group (MPEG) decoder, and processes FAT 1 channel. The second channel processing unit 25-2 supports a Digital Video Recorder (DVR), and processes FAT 2 channel. The third channel processing unit 25-3 includes an upstream part for communicating with a head end which is a broadcasting repeating device and a downstream (DOCSIS Set-top box Gateway (DSG) or Out Of Band (OOB)) part for communication with a broadcasting station user information provide server. One or more of the first channel processing unit 25-1 may be provided.

The display module 100 and the set-top box 200 transmit/receive the video terminal information through I-squared-C (I2C) of digital video terminals such as the HDMI terminals 110 and 210.

The set-top box 200 and the display module 100 are connected with each other via any one pair of the video terminals, such as a pair of the S-video terminals 12 and 22, a pair of the component terminals 13 and 23, a pair of DVI terminals 14 and 24 and a pair of HDMI terminals 110 and 210.

In the following, it will be assumed that the display module 100 is connected to the set-top box 200 via the component terminals 13 and 23 for transmitting the video signal and is also connected to the set-top box 200 via the HDMI terminals for transmitting the video terminal information.

First, the user selects a mode of the component terminals 13 and 23 using the user interface 11. Then, the display controller 120 of the display module 100 transmits video terminal information (component terminal information), selected via the user interface 11, to the set-top box 200 via the HDMI terminal 110.

When the video terminal information (component terminal information) is received, the terminal setting unit 220 of the set-top box 200 detects a video terminal (the component terminal), connected to the display module 100, from the video terminal information.

Then, the controller 230 of the set-top box 200 controls the video terminals via the terminal setting unit 220, so that video signals are output from the component terminals 13 and 23, but not from the S-video terminals 12 and 22, the DVI terminals 14 and 24 or the HDMI terminals 110 and 210.

The controller 230 of the set-top box 200 determines whether the video terminal information is received from the display module 100 in a predetermined reference time, and determines whether the display module 100 is in the on or off state based upon the determination.

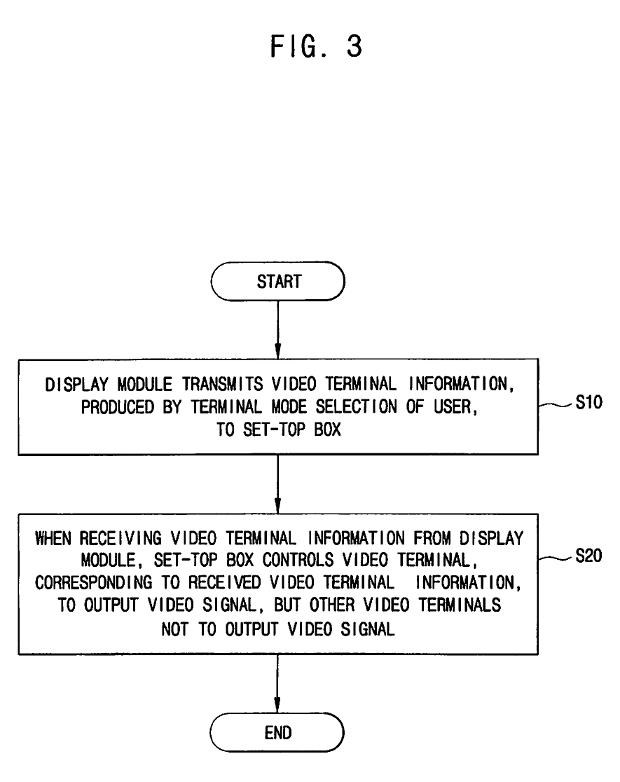

If the video terminal information is not received from the display unit 100 in the predetermined reference time, the controller 230 of the set-top box 200 controls the operation of the channel processing units 25 that process different types of video signals, received from the digital broadcasting system. Hereinafter, a power management method of the set-top box of the present invention, having the above-described construction, will be described with reference to FIG. 3. FIG. 3 is a flowchart illustrating a power management method of a set-top box according to the present invention.

Referring to FIG. 3, when the display module 100 is connected to the set-top box 200 via a digital video terminal, the display module 100 transmits video terminal information, produced by the terminal mode selection of a user, to the set-top box 200 via the HDMI terminal 110 in step S10. When the video terminal information is received from the display module 100, the set-top box 200 controls the video terminals, so that only the video terminal, corresponding to the received video terminal information, outputs video signals while the other video terminals do not output video signals in step S20.

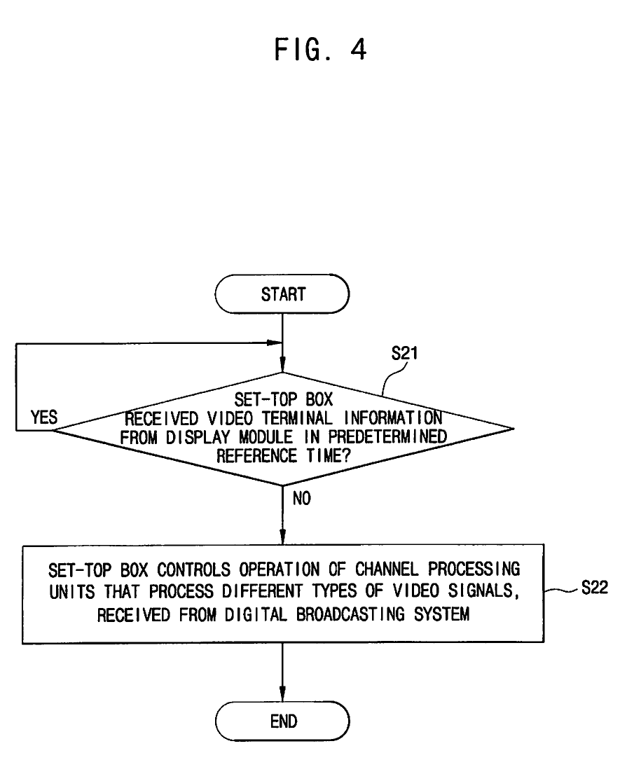

An on/off control process of the display module in the power management method will be described with reference to FIG. 4. FIG. 4 is a flowchart illustrating an on/off control process of a display module in the power management method of a set-top box according to the present invention.

Referring to FIG. 4, the set-top box 200 determines whether the video terminal information is received from the display module 100 in a predetermined reference time in S21.

If the video terminal information is not received from the display module 100 in a predetermined reference time in the determining step S21, the set-top box 200 determines that the display module 100 is in the off state, and controls the operation of the channel processing units 25 that process different types of video signals, received from the digital broadcasting system in S22.

The display module 100 and the set-top box 200 transmit/receive the video terminal information through I-squared-C (I2C) of the digital video terminals such as the HDMI terminals.

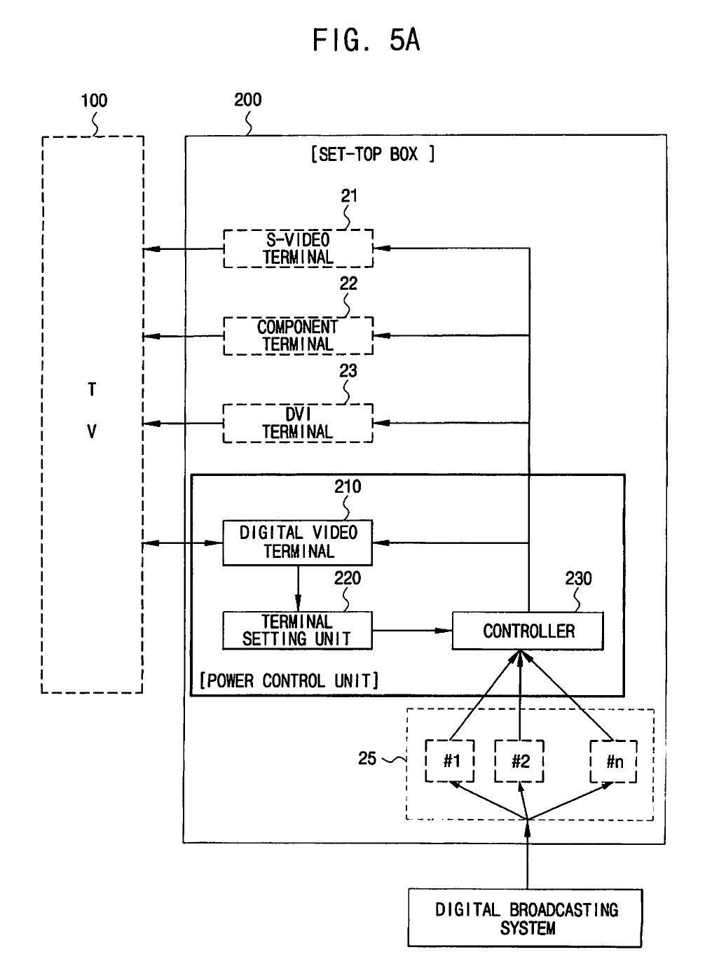

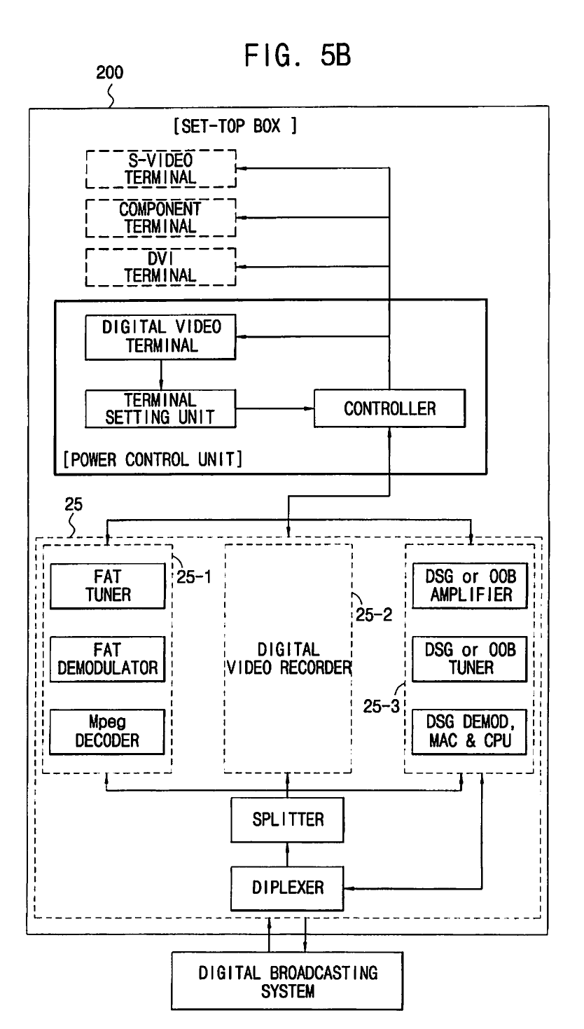

FIG. 5A is a block diagram illustrating the construction of a power manageable set-top box according to the present invention. The set-top box of the present invention includes a power control unit, which includes a digital video terminal 210, a terminal setting unit 220 and a controller 230.

When the video terminal information is received via the digital video terminal 210 from the connected display module 100, the power control unit controls the video terminals in such a fashion that a video terminal, corresponding to the video terminal information, can output video signals, but the other video terminals do not output video signals.

The terminal setting unit 220 of the power control unit detects a video terminal, connected to the display module 100, from the video terminal information, which is received via the digital video terminal 210 from the display module 100.

The controller 230 of the power control unit controls the signal output of the video terminals, in such a fashion that video signals can be outputted from the video terminal, corresponding to the video terminal information, but video signals are not outputted from the other video terminals.

The controller 230 determines the on/off state of the display module 100 based upon whether the video terminal information is received from the display module 100 in a predetermined reference time.

If it is determined that the display module 100 is in the off state as the video terminal information is not received from the display module 100 in a predetermined reference time, the controller 230 controls the operation of one or more channel processing units 25 that process different types of video signals, received from a digital broadcasting system. The digital video terminal 210 is an HDMI terminal, and the display module 100 and the power control unit transmit/receive video the terminal information to/from each other via I-squared-C (I2C) of the digital video terminal 210.

FIG. 5B is a block diagram illustrating the detailed construction of the set-top box in the power management system. As set forth above, the power management system and method of a set-top box of the present invention has excellent effects of reducing power consumption of the set-top box by receiving the information of a connected video terminal from a TV and controlling the other video terminals based upon the information.

While the present invention has been shown and described in connection with the preferred embodiments, it will be apparent to those skilled in the art that modifications and variations can be made without departing from the spirit and scope of the present invention as defined by the appended claims.

What is claimed is:

1. A power management system of a set-top box, comprising:
a display module that includes at least one video terminal, wherein the display module is connected to the set-top box via a digital video terminal, and transmits video terminal information produced by video terminal selection of a user to the set-top box via the digital video terminal; and
the set-top box that includes at least one video terminal,
wherein the set-top box includes a terminal setting unit detecting a video terminal connected to the display module based upon the video terminal information, which is received from the display module via the digital video terminal, and a controller allowing the detected video terminal connected to the display module to output video signals, and preventing other video terminals from outputting video signals.

2. The power management system according to claim 1, wherein the controller of the set-top box determines on/off information of the display module based upon whether the video terminal information is received in a predetermined reference time.

3. The power management system according to claim 2, wherein, when the display module is in an off state, the controller of the set-top box controls at least one channel processing unit not to operate, the channel processing unit processing different types of video signals received from a digital broadcasting system.

4. The power management system according to claim 3, wherein the channel processing unit comprises at least one of a first, a second and a third channel processing units, wherein the first channel processing unit includes a Forward Application Transport (FAT) tuner, a FAT demodulator, a Motion Picture Experts Group (MPEG) decoder, and processes FAT 1 channel, the second channel processing unit supports a Digital Video Recorder (DVR), and processes FAT 2 channel, and the third channel processing unit includes an upstream part for communicating with a head end that is a broadcasting repeating device and a downstream (DOCSIS Set-top box Gateway (DSG) or Out Of Band (OOB)) part for communication with the broadcasting station user information provide server.

5. A power management method in a system including a set-top box and a display module, each of which includes at least one video terminal, the method comprising:
transmitting, at the display module, video terminal information, produced by terminal mode selection of a user, to the set-top box via a digital video terminal; and
allowing, when the video terminal information is received from the display module via the digital video terminal, at the set-top box, a video terminal corresponding to the received video terminal information to output video signals, and preventing other video terminals from outputting video signals.

6. The power management method according to claim 5, further comprising:
determining, at the set-top box, whether the video terminal information is received in a predetermined reference time; and
when the video terminal information is not received from the display module in the predetermined reference time, further determining, at the set-top box, that the display module is in an off state, and controlling at least one channel processing unit not to operate, the channel processing unit processing different types of video signals received from a digital broadcasting system.

7. The power management method according to claim 6, wherein the channel processing unit comprises one of a first, a second and a third channel processing units, wherein the first channel processing unit includes a Forward Application Transport (FAT) tuner, a FAT demodulator, a Motion Picture Experts Group (MPEG) decoder, and processes FAT 1 channel, the second channel processing unit supports a Digital Video Recorder (DVR), and processes FAT 2 channel, and the third channel processing unit includes an upstream part for communicating with a head end which is a broadcasting repeating device and a downstream (DOCSIS Set-top box Gateway (DSG) or Out Of Band (OOB)) part for communication with the broadcasting station user information provide server.

8. A set-top box, comprising:
at least one digital video terminal for connecting to a digital video terminal of a display module;
a terminal setting unit for receiving video terminal information produced by video terminal selection of a user from the display module through the digital video terminal, and detecting the digital video terminal connected to the display module from the received video terminal information; and
a controller allowing the video terminal, corresponding to the video terminal information, to output video signals, and preventing other video terminals from outputting video signals.

9. The set-top box according to claim 8, wherein the controller determines that the display module is in an off state based upon whether the video terminal information is received in a predetermined reference time.

10. The set-top box according to claim 9, wherein, when the display module is in an off state, the controller controls at least one channel processing unit not to operate, the channel processing unit processing different types of video signals received from a digital broadcasting system.

11. The set-top box according to claim 10, wherein the channel processing unit comprises one of a first, a second and a third channel processing units, wherein the first channel processing unit includes a Forward Application Transport (FAT) tuner, a FAT demodulator, a Motion Picture Experts Group (MPEG) decoder, and processes FAT 1 channel, the second channel processing unit supports a Digital Video Recorder (DVR), and processes FAT 2 channel, and the third channel processing unit includes an upstream part for communicating with a head end which is a broadcasting repeating device and a downstream (DOCSIS Set-top box Gateway (DSG) or Out Of Band (OOB)) part for communication with the broadcasting station user information provide server.
